(19) United States
(12) Patent Application Publication
(10) Pub. No.: US 2015/0317580 A1
(43) Pub. Date: Nov. 5, 2015

(54) BUSINESS PERFORMANCE METRICS AND INFORMATION TECHNOLOGY COST ANALYSIS

(71) Applicant: INTERNATIONAL BUSINESS MACHINES CORPORATION, Armonk, NY (US)

(72) Inventors: Susanne Glissmann-Hochstein, San Jose, CA (US); Heiko Ludwig, San Jose, CA (US); Yuhichi Nakamura, San Jose, CA (US); Guangjie Ren, San Jose, CA (US); Glenn Theile, San Jose, CA (US)

(73) Assignee: INTERNATIONAL BUSINESS MACHINES CORPORATION, Armonk, NY (US)

(21) Appl. No.: 14/266,574

(22) Filed: Apr. 30, 2014

(51) Int. Cl. G06Q 10/06

(52) U.S. Cl. CPC G06Q 10/0639; G06Q 10/067

(57) ABSTRACT

Embodiments of the present disclosure relate to a method for modeling the relationship between a company's business performance metrics and information technology service costs. In one embodiment, a plurality of business architecture component descriptors and a plurality of measurement component descriptors are provided. Each descriptor includes at least one variable, corresponding to one of: a business metric, an information technology resource metric, a cost metric of an information technology resource, a service metric of an information technology service, or a cost metric of an information technology service. Business architecture components and measurement components are modeled from the descriptors. These business architecture components are coupled by a qualitative connector, and the measurement components are coupled by an executable connector defining a computable dependency between measurement components.

### BACKGROUND

Embodiments of the present disclosure relate to managing the cost of Information Technology (IT) infrastructure services, particularly for organizations whose IT costs represent a comparatively high percentage of their overall costs (e.g., finance, telecommunication, media industry sectors, etc.), as well as for IT infrastructure service outsourcers whose primary business is providing IT infrastructure services for others.

### BRIEF SUMMARY

According to one embodiment of the present invention, a method and computer program product for modeling the relationship between a company's business performance metrics and information technology service costs are provided. In one embodiment, a plurality of business architecture component descriptors and a plurality of measurement component descriptors are provided. Each descriptor includes at least one variable, corresponding to one of: a business metric, an information technology resource metric, a cost metric of an information technology resource, a service metric of an information technology service, or a cost metric of an information technology service. Business architecture components and measurement components are modeled from the descriptors. These business architecture components are coupled by a qualitative connector, and the measurement components are coupled by an executable connector defining a computable dependency between measurement components.

### BRIEF DESCRIPTION OF THE SEVERAL VIEWS OF THE DRAWINGS

FIG. 1 depicts value cost impact analysis modeling elements for an exemplary telecommunications embodiment of the present disclosure.

FIG. 2 depicts an exemplary qualitative model view according to an embodiment of the present invention.

FIG. 3 depicts exemplary business capability cost scenarios according to an embodiment of the present invention.

FIG. 4 depicts an exemplary business value assessment of IT alternatives according to an embodiment of the present invention.

FIG. 5 depicts an exemplary benchmark scoring feature according to an embodiment of the present invention.

FIG. 6 depicts an exemplary benchmark scoring method according to an embodiment of the present invention.

FIG. 7 depicts exemplary business metric specifications according to an embodiment of the present invention.

### DETAILED DESCRIPTION

Planning for a new application or additional demand typically involves building a new environment for this application with dedicated servers and storage, sized to also consider future demand. This approach results in low utilization rates of data center capacity. Migrating applications into virtualized environments in-house or by a public provider improves hardware utilization, enables further automation, and has the potential to align capacity with demand more elastically if a Cloud provider is used. While much of the technical capacity planning issues are addressed in a virtualized or Cloud environment, the impact of business developments on IT costs still remain, independently of the efficiency and elasticity of IT service management. It should be noted that the use of the term “business development” herein serves as a reference to the future development of key business metrics (e.g., revenue, number of employees, etc.).

Predicting the IT cost development of an organization depends on changes in IT infrastructure consumption based on business decisions and/or exogenous events. Although empirical data of average IT cost as a percentage of revenue in a particular industry or the cost of a benchmark company in a given industry may be available, such data are often too coarse and do not account for changes in the services the market demands. Accordingly, an aspect of the present disclosure relates relevant business metrics (e.g., revenue, number of customers, etc.) to the consumption of IT infrastructure services (e.g., server capacity, storage, end user devices, etc.) and the corresponding management and support of such IT services.

An example of the challenges presented in forecasting and/or accounting for IT service demand can be demonstrated with a mobile phone service provider which typically offers mobile voice and data services as separate packages, charging separately for each package. However, the competitive situation causes the provider to bundle unlimited multi-media messaging in its market at the base price given a rising trend of smart phone adoption. As a result, customer habits change and customers send many more multimedia messages containing images and videos, causing storage demand and its associated cost to rise significantly while impacting revenue only marginally. Consequently, this exemplary company needs a method of estimating its additional IT service demand beyond simple rules of thumb such as percentages of revenue. As an alternative approach, the provider could estimate in detail for different business development scenarios how many additional managed storage devices it would need, how many additional servers this might take, and the corresponding data center fabric, raised floor space and labor depending on the current situation. This, however, is typically too much effort and is prone to too much error, particularly if a number of different scenarios need to be considered. While a telecommunications example is provided for purpose of illustration, it will be readily apparent to an artisan of ordinary skill that the present disclosure extends to any industry with IT services or demands.

Inaccurate cost prediction/accounting is an even bigger problem for IT service providers offering performance-based pricing alternatives to traditional service consumption-based pricing methods, as they have become increasingly relevant in the IT outsourcing marketplace. In performance-based pricing schemes, an IT outsourcer charges a customer according to performance targets that are relevant for a customer's business such as revenue or subscriber numbers in the mobile phone example discussed above. Therefore, it is important for an IT outsourcer to understand the relationship between contracted performance targets and IT infrastructure service consumption so that it does not make the business decisions driving significant changes in IT costs, such as the increase in multi-media message.

Models to relate business metrics to IT service costs can be created specifically for each IT service contract in collaboration between the customer and the service provider, considering a limited set of scenarios for future business development due to the high cost of model creation. However, this creates significant risk to profit for IT outsourcers and limits this approach to very large deals due to the high cost of model creation.

Accordingly, the present disclosure provides an approach to model the relationship between a company's business performance metrics and IT service costs in an effective way. The disclosed computer program products and corresponding methods use default models based on empirical data that relate business capabilities and associated metrics to IT service elements based on proportional allocation typical for a specific industry. For a given company, this model can be adjusted based on differences in scale and company specifics in its given market. Such a model can then be the basis of a cost sensitivity analysis, iterating through various business development scenarios identifying those business metrics having potentially large cost impact. The identified IT costs can be further used to derive an IT cost benchmark score for a generic cost comparison with other companies in the same or different industry sectors. In addition to performance-cost analysis, very often companies have to decide between technology alternatives. The method disclosed herein can be employed in such scenarios to identify the business value that each alternative offers.

Associating business metrics with IT cost drivers requires understanding how a business consumes IT services. In the exemplary embodiments disclosed herein, the reference to business architecture is used to describe the structure of a business and provides a foundation to assess how changes to high-level metrics (e.g., revenue, number of customers, etc.) impact the number of processes executed and inputs consumed, and in turn how different technology alternatives may have an impact on business performance. With the business architecture of an organization established, the present disclosure can tie it to the IT services used to implement the architecture and operate the business in practice. While costs are typically accounted for in the context of IT services, not all parts of a business consume IT services equally or linearly. Accordingly, an understanding of how IT consumption is measured, which ties business metric development to IT cost drivers is needed, as described below.

The elements and approach for the value cost impact analysis in the present disclosure is based on the concept of Business Architecture (BA). While several Business Architecture propositions are available, these business architectures differ in their objectives, type and number of elements, as well as their granularity level. As the development of these known models can be time-consuming, industry default models have been developed that can be customized to a specific company situation and thus reducing the development effort of a model. Common industry default models are, for instance, the enhanced Telecom Operations Map (eTOM) Business Process Framework, and the IBM Insurance Application Architecture.

The BA foundation employed in the present disclosure leverages the notion of modularization or componentization of business operations, also referred to as business components or business capabilities. These BA elements are modular building blocks that collectively make up the operational structure of the specialized enterprise. A business capability conducts a set of activities supported by resources (e.g., people, processes, applications, etc.). Decision makers can use component based analysis of their business operations, as disclosed herein, for a myriad of objectives and particularly to identify areas of the business that require attention given certain performance measurements or other targets. In some embodiments, heat maps can be used during strategic decision making in order to identify the most relevant components for the business.

Further elements associated with Business Architecture are IT related elements, such as IT assets, IT resources, IT solutions, applications and IT services. These elements are associated with typical elements of the business (e.g., business processes or business capabilities) to illustrate how the IT supports the business and help understand the business value of IT services.

A significant part of IT costs are often the labor costs of IT operation services. Thus, in order to predict how the overall IT costs will develop over time, a good understanding of the impact business changes have on IT operation services is required. While IT service providers often have their own IT services specified, commonly used best practice processes of IT service management are provided by The Information Technology Infrastructure Library (ITIL).

The computer program products and methods of the present disclosure encompass, but are not limited to, the IT services described in ITIL such as: event management to monitor all events that occur through the IT infrastructure; incident management to restore unexpectedly degraded or disrupted services to users; problem management to determine and resolve the underlying causes of events and incidents, and access management to grant authorized users the rights to use a service. Additionally, the present disclosure encompasses backend IT functions including, but not limited to, server and mainframe management and support, network management, storage and archive, database administration, as well as Internet management.

As the present disclosure deals with relating business metrics to IT infrastructure service costs, it is important to measure which parameters and criteria determine the cost. This is primarily the utilization of IT infrastructure services, as opposed to quality-of-service (QoS) metrics. In some embodiments a more differentiated cost model may consider choosing between violating an SLA or provisioning additional resources, but for the purposes of illustration and not limitation, the exemplary embodiments disclosed herein focus on IT infrastructure service consumption.

Some exemplary consumption metrics for IT infrastructure services typically relate to: i) the consumption of IT infrastructure itself such as servers, storage and network bandwidth; ii) the use of licenses; iii) the consumption of services related to user requests such as incident and problem management as well as service request management; and iv) the consumption of services directly related to users such as identity and access management.

Infrastructure consumption metrics can also be collected and processed automatically from system instrumentation, in particular from automated environments such as cloud platforms and storage management systems. While metrics instrumentation, definition and access has been standardized by industry organizations such as the Distributed Management Task Force (DMTF), actual metric definitions are often idiosyncratic to a specific technology vendor or IT infrastructure service provider but are typically generally understood. Examples of some consumption metrics of the present disclosure are provided in TABLE 1 below.

Additionally, environmental costs (e.g., raised floor area, power consumption, routine service operation, etc.) can be aligned with infrastructure consumption itself. Software license use can be detected automatically, and while it is possible to meter license usage in the context of the compute unit that uses the license (e.g., images), this is often not convenient. Beyond the operating systems, there is typically too much variety of software configurations on a system to count each configuration type separately. Service management consumption metrics relate to service processes as previously described. Furthermore, the present disclosure can measure service management consumption metrics instrumenting a service management system which utilizes the types of “tickets” as the units to be counted. The number of tickets expected often aligns with the number of users rather than the number of systems.

TABLE 1
Exemplary Consumption Metrics

| Service | Unit |
|---|---|
| Servers | Rack Units |
| Intel Server Image | Intel Images |
| Unix Server Image | Unix Images |
| Networking | TB/Day |
| Application Operations | Application Images |
| Batch Operations | Batch Kjobs/Mon |
| Database _DB2 | DB2 DBs |
| Database Oracle | Oracle DBs |
| Middleware | MQ Series Instances |
| Server Planning | Images Types Planned |
| Help Desk | Busines Hour Calls/Day |
| Media Management | Tape GB |
| Managed Storage | DASD GB |
| . . . | . . . |

In accordance with an aspect of the present disclosure, in an effort to align business metrics with IT cost drivers, the relevant set of metrics for a specific case is determined by their alignment with IT infrastructure service costs specific to the service providing IT organization in question.

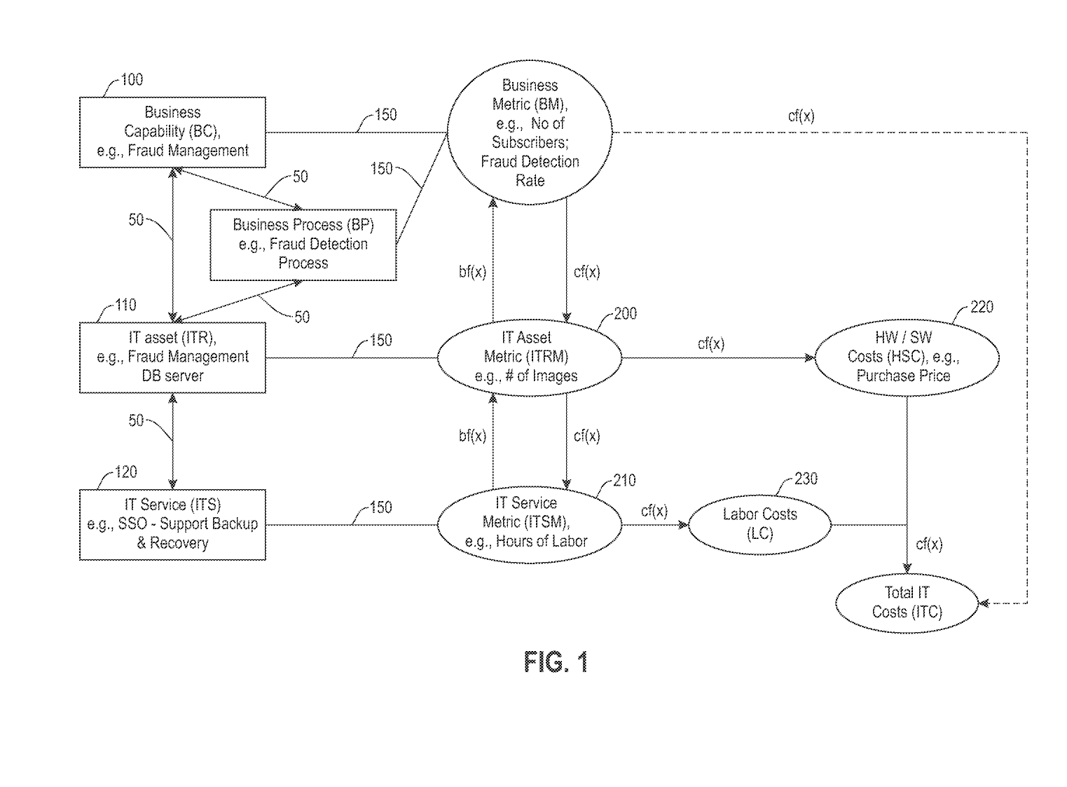

An exemplary embodiment of the present disclosure of modeling elements for value cost impact analysis is illustrated in FIG. 1. The model describes the business and IT environment of a company with the goal to predict efficiently and accurately the impact business changes have on the long term IT service delivery costs and profit risks, as well as the impact that different technology alternatives have on business. The elements contain architectural components, measurement components, as well as qualitative and quantitative connectors.

With reference now to FIG. 1, the architectural components 100, 110, 120 are graphically represented by rectangular elements, while measurement components 200, 210, 220, 230 are graphically represented by oval-shaped elements. Although the exemplary embodiment depicted illustrates specific architectural components, it is to be understood that the present disclosure can include any number of architectural components as so desired. Furthermore, as the number of architectural components employed in the present disclosure is increased, the accuracy of the results will likewise increase.

The business capability element 100 represents a proficiency that is in a company's long term interest and that predictably produces observable outcomes. In some embodiments, industry capabilities maps (which are available for various industries) can be used to select the key capabilities of relevancy for a specific client. For example, the enhanced Telecom Operations Map (eTOM), business process framework offers industry maps in different levels of granularity. The processes defined in the higher level eTOM maps can be used to identify business capabilities for use with the system and methods of the present disclosure. Additional exemplary maps include the IBM Insurance Application Architecture and other component or capability maps provided by IT consulting companies, such as IBM and Capgemini.

The second architectural component in exemplary FIG. 1 is the IT asset 110 (shown as a rectangular element thereby denoting an architectural component). The IT asset can be of type hardware or software, or combinations thereof. Key software to be modeled when employing the present disclosure includes the business applications used by the business capabilities. Other relevant software can include supporting software, such as operating system or storage management software. Key hardware assets are in particular different types of servers, such as the application server, web server, database server, or the test server. In the interest of minimizing the modeling effort associated with the present disclosure, instead of specific instances, only the IT asset types are defined with information on how many instances are required for the specific business capability and the specific characteristics of the company.

The third architectural component is the IT service 120 (again shown as a rectangular element thereby denoting an architectural component). IT services are rather labor intensive and thus usually represent a large part of the long term IT costs. Some examples for IT services are provided by ITIL as discussed above and include, but are not limited to, services such as event management, incident management, problem management or access management.

Referring again to FIG. 1, measurement components 200, 210, 220, 230 (which are graphically represented by oval-shaped elements) are provided which measure the corresponding architectural components. For purpose of illustration and not limitation, these measurement components can comprise the following type: business metric (e.g., revenue, number of subscribers), IT asset metric (e.g., number of images, number of CPUs), IT service metric (e.g., hours of labor), hardware/software cost metric, labor cost metric and total IT costs.

In accordance with an aspect of the present disclosure, the modeling components (i.e. architectural and measurement) discussed above are associated with each other using three different relationship types.

First, qualitative directional connectors 50 (which are graphically represented by line segments with arrows) define the dependencies between architectural components 100, 110, 120. The direction of these connectors (indicated by the arrow heads) determines the direction of the executable connectors between measurement components.

Second, qualitative generic connectors 150 (which are graphically represented by line segments without arrows) define the dependencies between the architectural components and the measurement components, i.e., the specific measurement components of an architectural component.

Third, the executable connectors define the dependencies between the measurement components. As shown in FIG. 1, there are two different types of functions, a cost function cf(x) and a benefit function bf(x). In some embodiments the measurement components are independent variables determined by the user. In other embodiments, the measurement components are dependent variables which are computed with a formula referencing one to many source measurement components in order to determine the value of the target measurement component. The indirect executable connectors (which are graphically represented by a dashed or broken line) represent the indirect association between the initial source measurement components (i.e., business metrics) and the final target measurement components (i.e., the total IT costs). For purposes of illustration and not limitation, an exemplary relationship between the cost function is provided below which is premised on the assumption depicted in Equation (1):

CostCategory_{y}=f(Capability₁,Metric₁)+ . . . +f(Capabilityₙ,Metricₘ) (1)

such that costs are driven by independent function of business capabilities and business metrics. As such, the techniques disclosed herein allow for differentiated analysis of cost driver impact of different client metrics on IT services for different business function. An example of which is depicted by the formula presented in Equation (2):

$$\frac{\partial {CostCategory}_{y}}{\partial {Metric}_{x}} = {\sum }_{i} \frac{\partial f ( {Capability}_{i} , {Metric}_{x} )}{\partial {Metric}_{x}} \qquad ( 2 )$$

Likewise, the benefit function can be provided with a similar formula.

In accordance with another aspect of the value cost impact analysis system and method disclosed herein, a specific client (or industry) model can be created without the benefit of a model template. The model disclosed herein provides general indications on how IT costs will be impacted by the company's changing business. Each step is explained and illustrated with selected data of an industry default model created for the Telecom industry exemplary embodiment shown in FIG. 1.

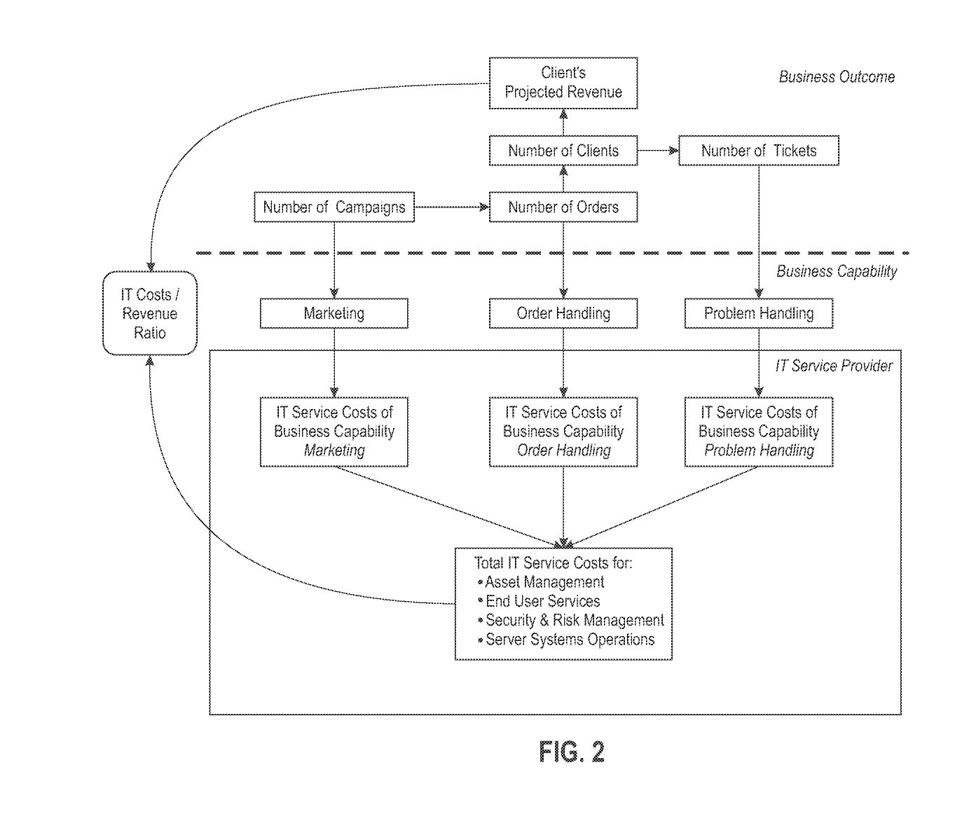

To create a specific case model, users first define the business capabilities to be outsourced to the IT service provider. While the exemplary embodiment in FIG. 2 depicts an outsourced arrangement, the model disclosed herein is equally applicable for scenarios in which the IT service is not outsourced, but instead provided by the same company. For this purpose, a user reviews industry capability maps to select key business capabilities that are most relevant to the client.

In the exemplary embodiment shown in FIG. 2, three key business capabilities were selected from the eTOM process framework, i.e., Product Marketing Communications & Promotion, Order Handling and Problem Handling. The marketing capability is responsible for the issue and distribution of marketing collateral directly to a customer and the subsequent tracking of resultant leads. The order handling capability deals with pre-order feasibility determination, credit authorization, order issuance, order status and tracking, customer update on order activities and customer notification on order completion. The problem handling capability is responsible for receiving trouble reports from customers, resolving them to the customer's satisfaction and providing meaningful status on repair and/or restoration activity to the customer.

As a next step, the solution architect defines the IT assets that are used for a particular business capability, as well as the IT services required for the selected IT solutions.

In the exemplary embodiment shown in FIG. 2, the solution architect focused in particular on the business applications typically used for the defined business capabilities. For the marketing capability two business applications, for order handling one business application and for problem handling one business application were identified. For sake of simplicity, no further software types were defined, though additional types can be included, if so desired.

Furthermore, four IT services that are related to some of the ITIL IT services were identified as main cost drivers and connected to the business applications: i) Asset Management to track and manage hardware and software assets from acquisition to disposal; ii) End User Services to deliver help desk, desk side support, and software platform management services across the globe; iii) Security and Risk Management to provide discrete rate card services to supplement security programs and ensure audit readiness; and iv) Server Systems Operations to manage the operations of server, storage, and operations of internal and customer commercial datacenters.

In a following step, one with industry knowledge develops bottom-up the business performance model. First, the business metrics that have a direct impact on the business applications, and thus on the IT service costs of the identified business capabilities, are defined. Next, a metric graph is built wherein further business metrics are defined that connect these first metrics to the highest level of business metrics representing the overall business objectives of the company (e.g., revenue increase). Accordingly, the company's business changes can be simulated by determining values for the company's general business objectives and other important business metrics. In addition to company internal metrics, external business metrics can be applied to describe their impact on the company's internal business metrics. Some examples for the telecommunications embodiment include number of cell phone users or fix line users per country, customer spending behavior, unemployment rate, etc.

In the example shown in FIG. 2, for the Business Capability “Marketing”, the business metric “Number of [email] Campaigns” is defined as a key metric that drives IT costs. Likewise, for the Business Capability “Order Handling”, the “Number of orders” is defined as a key metric that drives IT costs. Similarly, for the Business Capability “Problem Handling” the “number of tickets” is defined as a key metric that drives IT costs. These metrics are then connected as follows with the company's objective to increase revenue. For instance, to increase the company's revenue the number of subscribers has to grow. In order to grow the number of subscribers, the company has to increase the number of email campaigns entailing an increase in number of orders given a certain email campaign and order success rate. With an increasing subscriber base the total number of problem tickets will also increase.

After creating the qualitative business performance model, the quantitative view of the model is developed for the simulation of different business scenarios. For this, the dependent and independent variables are identified, the initial values of the independent metrics are determined and the formulas to compute the dependent variables are described. Finally, further auxiliary independent variables, such as the order success rate or email campaign success rate, are defined to allow the simulation of the model. Table 2 Error! Reference source not found. lists some exemplary business metrics defined for the sample case.

TABLE 2
Exemplary Business Metrics (BM)

| Business metrics | | | Metric level | | | |
|---|---|---|---|---|---|---|
| | | Initial value (year 0)/ | | | Order | Problem |
| Name | Type | simplified formula | Enterprise | Marketing | handling | Handling |
| Revenue | Indep. | $3,000,000,000 | X | | | |
| Avg. revenue per subscr. | Indep. | $1,200 | X | | | |
| No. of subscr. | Dep. | Revenue ÷ | X | | | |
| | | Avg. revenue per subscr. | | | | |
| No. of new subscr. | Dep. | No of subscr. (year_{I}) − | X | | | |
| | | No of subscr. (year_{I-1}) - | | | | |
| No. of orders | Dep. | No. of new subscr. + (No. of new | | | X | |
| | | subscr. ÷ Order success rate × | | | | |
| | | (100 − Order success rate)) | | | | |
| Order success rate | Indep. | 50% | | | X | |
| No. of email campaigns | Dep. | No. of orders. + (No. of orders ÷ | | X | | |
| | | Campaign success rate × (100 − | | | | |
| | | Campaign success rate)) | | | | |
| Campaign success rate | Indep. | 30% | | X | | |
| Ticket per subscr./month | Indep. | 0.2 | | | | X |
| No. of tickets | Dep. | No. of subscr. × Ticket per | | | | X |
| | | subscr./month | | | | |

In addition to the business performance model, the IT performance model is developed by the technical roles. It is composed of a graph of IT asset metrics and IT service metrics. Thereby, a few IT asset metrics form the interface to the business performance model. Furthermore, some IT asset metrics are directly connected to the IT service metrics entailing a direct impact on the IT service costs. Similar to the business performance model, in the IT performance model the dependent and independent variables are defined, the initial values of the independent metrics are determined, and the formulas to compute the dependent variables are described. If necessary, auxiliary metrics are created. Although, in general, the same types of IT metrics can be assigned to each business capability, the formula and value of these metrics may be different between the business capabilities. Some exemplary IT metrics that were defined for the sample case are listed in Table 3 below.

TABLE 3
Exemplary IT Metrics

| IT metrics | | Business capabilities | | |
|---|---|---|---|---|
| Name | Type | Marketing | Order Handling | Problem Handling |

IT assets

| | | | | |
|---|---|---|---|---|
| user capacity per day | Indep. | 5 email | 80 orders | 40 tickets |
| | | campaigns | | |
| No. of users | Dep. | No. of email | No. of orders ÷ | No. of tickets ÷ |
| | | campaigns ÷ | user capacity | user capacity |
| | | user capacity | | |
| No. of business apps | Indep. | 2 | 1 | 1 |
| Image capacity per | Indep. | 1:10,000 | 1:5,000 | 1:2,500 |
| business item | | | | |
| No. of images per app | Indep. | 2 | 1 | 1 |
| (baseline) | | | | |
| No. of images per app | Dep. | No. of email | No. of orders ÷ | No. of tickets ÷ |
| (extended) | | campaigns ÷ | img. capacity | img. Capacity |
| | | img. capacity | | |

IT services - End User Services

| | | | | |
|---|---|---|---|---|
| Avg. time per user/ | Indep. | 3 min | 3 min | 2 min |
| month | | | | |

| | | |
|---|---|---|
| Avg. costs per min. | Indep. | $10.00 |
| Total time | Dep. | No. of users × Avg. time per user/month × 12 |
| Total IT service costs | Dep. | Total time × Avg. costs per min. |

IT services - Server and Systems Operations

| | | | | |
|---|---|---|---|---|
| Avg. time per image/ | Indep. | 1 min | 10 min | 2 min |
| month | | | | |

| | | |
|---|---|---|
| Avg. costs per min. | Indep. | $7.50 |
| Total time per year | Dep. | No. of images × Avg. time per image/month × 12 |
| Total IT service costs | | Total time × Avg. costs per min. |

A key metric that has been identified for instance as driver for end user services is the number of users. While this metric is relevant for various business capabilities, its value creation formula differs among them. The metric is driven by the business capability specific business items (e.g., emails, orders, tickets), as well as the user capacity to process these business items.

Another key IT asset metric driving the IT service Server Systems and Operations is the number of images. In the sample case, the number of images are defined for a baseline, i.e., for a minimum number of business items, as well as for the processing of additional business items. In the latter case the number of images will grow linear. The formula to compute this metric value uses the total number of business items and the image capacity per business item.

Building on the experiences of previous IT sourcing projects, for each IT service the average time to process the business capability specific cost driver metric is defined. For instance, for the IT service “End User Services” of FIG. 2, it is defined how much time it takes to support one user per month, for the IT service “Server and Systems Operations” it is defined how much time it takes to manage one image per month.

In a long term outsourcing project changing business conditions will require changes of the IT infrastructure causing IT service costs to develop accordingly. The business changes are difficult to predict as they can be caused by various events. Accordingly, the model of the present disclosure is configured to demonstrate how the IT service costs might change by creating potential business scenarios. A business scenario builds on the before defined initial values, as well as time series of independent business metrics that reflect the changing business conditions. In the example case, two business scenarios were created (see Table 4).

TABLE 4
Exemplary Business Scenarios

| Business metrics | years | | | | | | | |
|---|---|---|---|---|---|---|---|---|
| (in %) | 1 | 2 | 3 | 4 | 5 | 6 | 7 | . . . |
| Scenario 1 | | | | | | | | |
| Increase in revenue | 10 | 10 | 10 | 10 | 10 | 10 | 10 | . . . |
| Increase in order success rate | 2 | 3 | 5 | 7 | 10 | 2 | 2 | . . . |
| increase in campaign success rate | 0 | 0 | 0 | 0 | 0 | 0 | 0 | . . . |
| Scenario 2 | | | | | | | | |
| Increase in revenue | 3 | 6 | 10 | 7 | 3 | 2 | 0 | . . . |
| Increase in order success rate | 1 | 1 | 1 | 1 | 1 | 1 | 1 | . . . |
| increase in campaign success rate | 2 | 5 | 8 | 10 | 11 | 12 | 13 | . . . |

In the first scenario, it was assumed that the company would be able to increase its revenue every year by 10%; due to the introduction of a new order management system an annual increase of the order success rate was expected. The email campaign success rate was assumed to remain the same over a time period of 10 years. The two dependent metrics, i.e., number of email campaigns and number of orders, were computed by the method disclosed herein.

In the second scenario, it is assumed that the revenue will increase in the first years and then stagnate in the following years. This increase is explainable with a growing campaign success rate due to a new campaign management system. The order success rate only increased marginally due to minimal changes in the order handling processes. Given these changes, the values of the dependent metrics number of email campaigns and number of orders were automatically adjusted by the method disclosed herein.

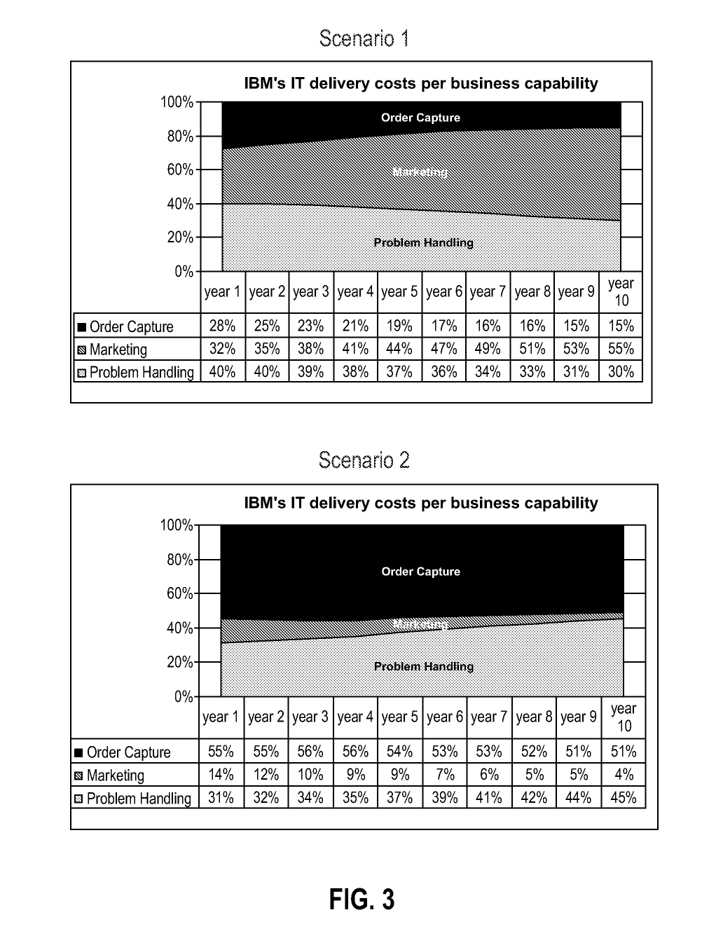

Based on the initial values of the business and IT performance model, as well as the defined business scenarios the corresponding cost scenarios are computed by the system disclosed herein. FIG. 3 illustrates the cost scenarios that were created for the above two business scenarios. The two charts show how the relative IT service costs of the three business capabilities differ between the two scenarios. Additionally, the total IT service costs (not illustrated in the charts below) vary between the two scenarios.

In the first scenario, the increasing IT service costs for the business capability marketing is explainable with the constant annual increase in revenue which requires a higher number of email campaigns to be met, along with additional marketing personnel for processing these campaigns. In particular, the increasing number of marketing personnel impacted the number of users for the marketing capability, and thus the need and costs for end user services. As the order success rate in this scenario increased, the need for new employees decreased over time with the result that the number of users remained the same and therefore in particular the IT service costs for end user services stagnated. The costs for server and systems operations increased more significantly for marketing due to an increase in number of images for this capability.

In the second scenario, the quickly increasing campaign success rate requires fewer marketing campaigns and thus fewer users working with the marketing applications. However, the number of users for order handling and thus the costs of end user services are highly impacted. The higher IT service costs for order handling are furthermore explained by the increased number of images needed for this particular business capability, as well as by the higher average costs per image for the IT service server systems and operations.

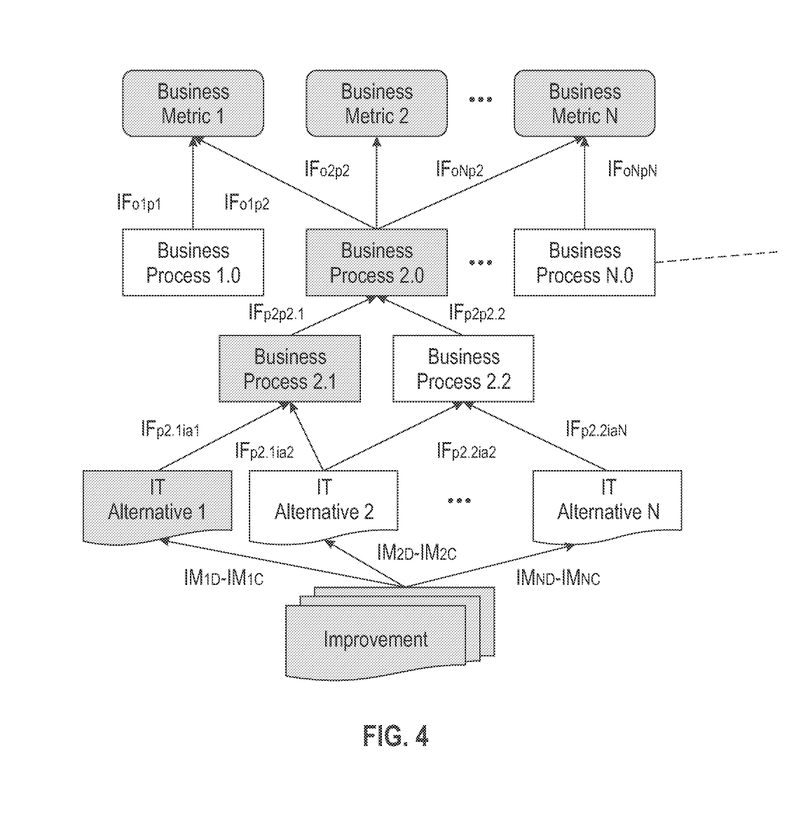

In accordance with another aspect of the present disclosure, with the above business architecture, companies can also conduct business value assessment when they are facing different IT alternatives, including IT assets, services, and simply information. As shown in FIG. 4, the relationships between Business Process and Business Metrics are firstly identified and then the ones among Business Processes. Such relationships can be quantified as Impact Factors, such as IFo₁p₂ and IFp₂p_{2.1}. The value of Impact Factors depends on a few factors, including the relevance of one relationship as opposed to others, the frequency of process execution, etc. For instance, when a unit of improvement in Business Process 2.0 generates four units of improvement in Business Metric 1, then IFo₁p₂=4. In a similar way, the relationships between IT alternatives and Business Processes can also be defined.

With the above relationships, the improvement that an IT alternative (e.g., an information platform) makes to lower-level Business Processes can then be escalated to higher-level Business Processes and ultimately Business Metrics. As an example illustrated in FIG. 4, the value of IT alternative 1 can be expressed as the following:

$$Value of IT alternative 1 = SUM ( Impact on Outcome 1 , Impact on Outcome 2 , Impact on Outcome 3 ) = ( ( {IM}_{1 D} - {IM}_{1 C} ) \times {IF}_{p 2} \cdot {1}_{ia 1} \times {IFp}_{2} {p}_{2.1} \times {IFo}_{1} {p}_{2} ) + ( ( {IM}_{1 D} - {IM}_{1 C} ) \times {IF}_{p 2} \cdot {1}_{ia 1} \times {IFp}_{2} {p}_{2.1} \times {IFo}_{2} {p}_{2} ) + ( ( {IM}_{1 D} - {IM}_{1 C} ) \times {IF}_{p 2} \cdot {1}_{ia 1} \times {IFp}_{2} {p}_{2.1} \times {IFo}_{3} {p}_{2} ) = ( ( {IM}_{1 D} - {IM}_{1 C} ) \times {IF}_{p 2} \cdot {1}_{ia 1} \times {IFp}_{2} {p}_{2.1} ) \times ( {IFo}_{1} {p}_{2} + {IFo}_{2} {p}_{2} + {IFo}_{3} {p}_{2} )$$

With the same calculations for IT alternative 2 and 3, companies can compare the business value of IT alternatives and decide which one to select from both business value and cost impact perspectives.

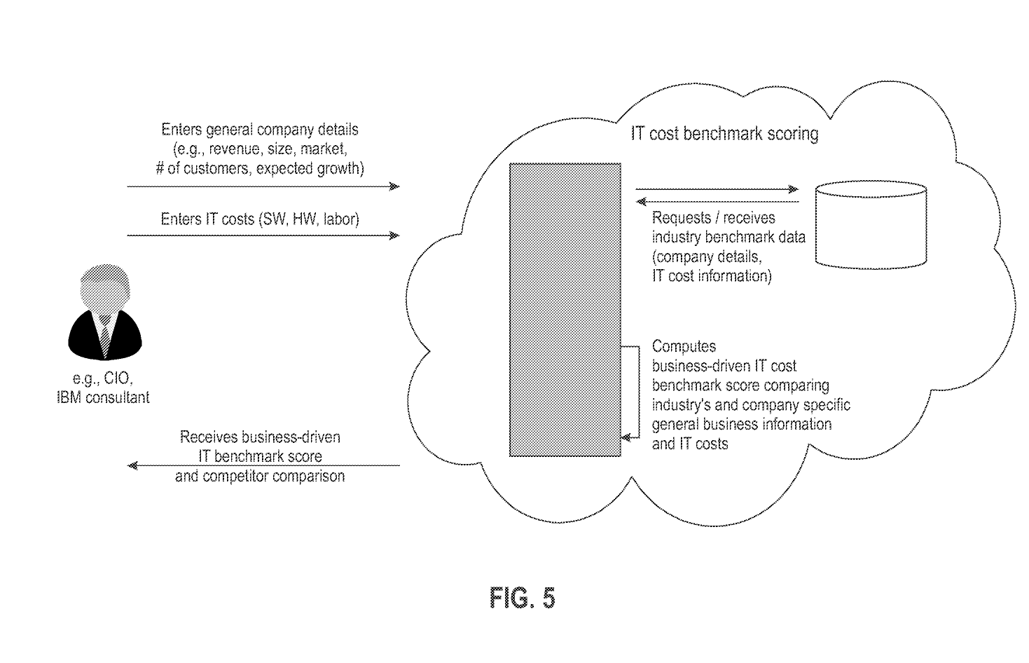

In accordance with another aspect of the present disclosure, the created company-specific cost model can be further used to derive an IT cost benchmark score. This score can resemble a credit score that can be used to compare in a generic way the particular company with other companies in a similar, as well as in different situations. For this, additional business information needs to be provided about the company (e.g., revenue, size, market, # of customers, expected growth). The industry sector and business information is then used to identify a comparable business reference cost model and a corresponding IT reference model. The IT reference model represents the ideal IT situation with ideal IT costs for the given business situation. An illustrative example of such benchmarking is provided in FIG. 5.

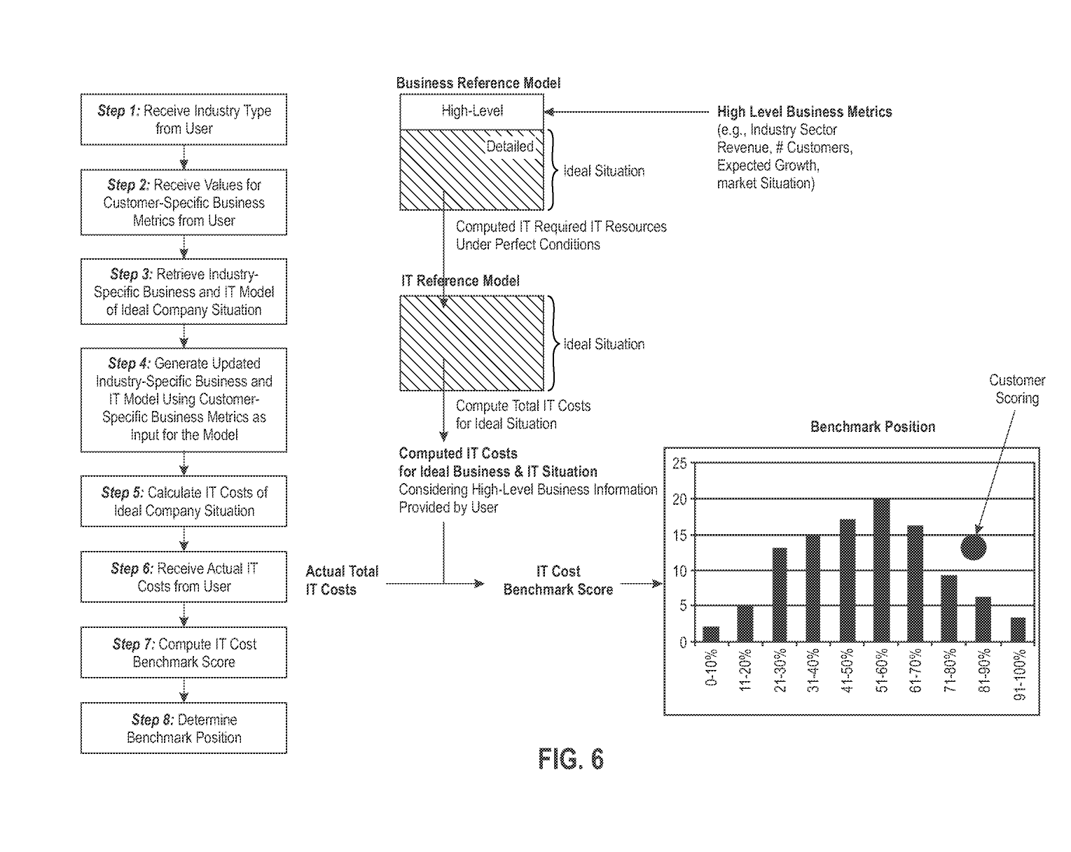

The difference between the costs of the ideal IT situation and the actual IT costs is used to compute the IT benchmark score. FIG. 6 illustrates the necessary steps to determine the IT benchmark score.

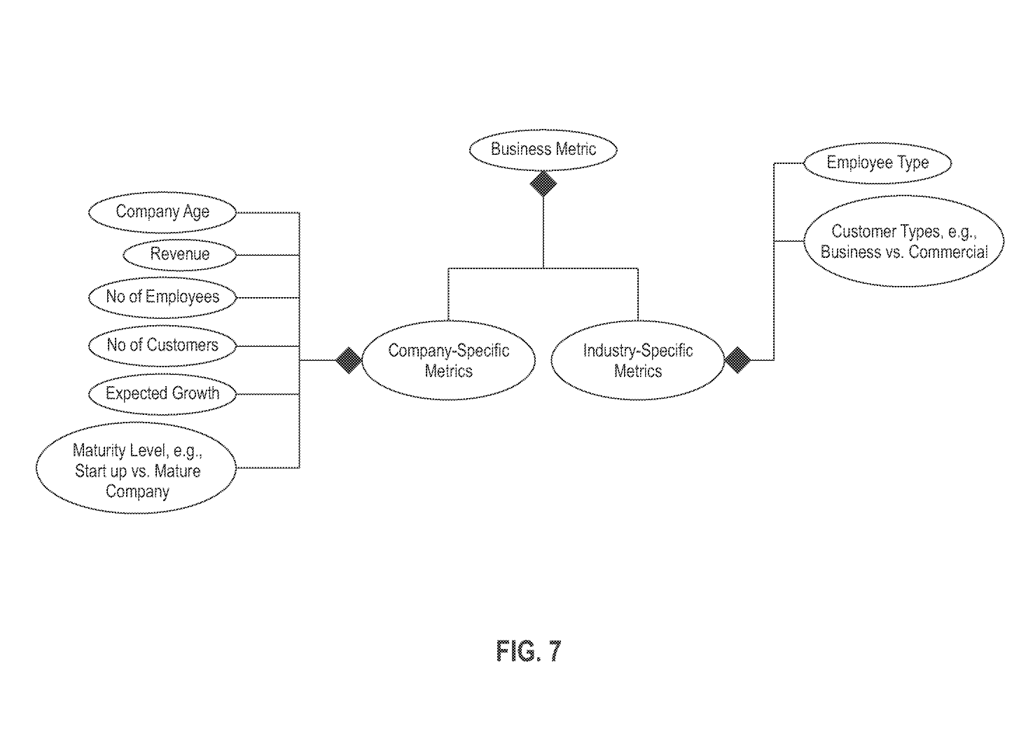

Furthermore, the accuracy and effectiveness of the present disclosure can be enhanced by the amount of detail provided in the defining the element business metric of the metamodel. Accordingly, FIG. 7 illustrates some exemplary metric elements that, if available, can assess the company's business situation in more detail.

Referring to FIGS. 1-7, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
providing a plurality of business architecture component descriptors;
providing a plurality of measurement component descriptors, each measurement component descriptor comprising at least one variable selected from the group consisting of:
a business metric,
an information technology resource metric,
a cost metric of an information technology resource,
a service metric of an information technology service, and
a cost metric of an information technology service;
modeling a plurality of business architecture components corresponding to the plurality of business architecture component descriptors;
modeling a plurality of measurement components corresponding to the plurality of measurement component descriptors;
coupling a first one of the business architecture components with a second one of the business architecture components by a qualitative connector; and
coupling a first one of the measurement components with a second one of the measurement components by an executable connector defining a computable dependency between the first and second measurement components.

2. The method of claim 1, wherein the plurality of business architecture component descriptors includes at least one variable selected from the group consisting of:
a business capability,
an information technology resource, and
an information technology service.

3. The method of claim 1 wherein the qualitative connector is a directional connector.

4. The method of claim 1, comprising:
coupling the first one of the business architecture components with the first one of the measurement components by a second qualitative connector.

5. The method of claim 1 wherein the second qualitative connector defines a computable dependency between the first one of the business architecture components and the first one of the measurement components.

6. The method of claim 1 wherein the executable connector comprises: (i) a direct connection between the first and second measurement components and (ii) a cost function.

7. The method of claim 1 wherein the executable connector comprises an indirect connection between the first and second measurement components and include a benefit function.

8. The method of claim 1 wherein the executable connector includes independent variables determined by a user.

9. The method of claim 1 wherein the executable connector includes dependent variables computed from a measurement component.

10. The method of claim 1 wherein the plurality of business architecture component descriptors are based on an industry map.

11. The method of claim 1 comprising deriving an information technology benchmark score from industry data.

12. The method of claim 1 comprising predicting the impact that changes in business architecture elements have on information technology costs in view of changes in business architecture components or measurement components.

13. A computer program product for processing information technology infrastructure costs, the computer program product comprising a computer readable storage medium having program code embodied therewith, the program code executable by a processor to:
identify a plurality of business architecture component descriptors;
identify a plurality of measurement component descriptors, each descriptor comprising at least one variable selected from the group consisting of:
a business metric,
an information technology resource metric,
a cost metric of an information technology resource,
a service metric of an information technology service, and
a cost metric of an information technology service;
instantiate a plurality of business architecture components corresponding to the plurality of business architecture component descriptors;
instantiate a plurality of measurement components corresponding to the plurality of measurement component descriptors;
couple a first one of the business architecture components with a second one of the business architecture components by a qualitative connector; and
couple a first one of the measurement components with a second one of the measurement components by an executable connector defining a computable dependency between the first and second measurement components.

14. The computer program of claim 13 wherein the qualitative connector is a directional connector.

15. The computer program of claim 13, wherein the program code couples the first of the business architecture components with the first of the measurement components by a second qualitative connector.

16. The computer program of claim 13 wherein the second qualitative connector defines a computable dependency between the first of the business architecture components and the first of the measurement components.

17. The computer program of claim 13 wherein the executable connector comprises: (i) a direct connection between the first and second measurement components and (ii) a cost function.

18. The computer program of claim 13 wherein the executable connector comprises: (i) an indirect connection between the first and second measurement components and (ii) a benefit function.

19. The computer program of claim 13 wherein the executable connector includes independent variables determined by a user.

20. The computer program of claim 13 wherein the executable connector includes dependent variables computed from a measurement component.

21. The computer program of claim 13 comprising deriving an information technology benchmark score from industry data.

22. A computer-implemented method comprising:
providing values for certain business metrics; and
coupling a business metric with a computed metric by an executable connector defining a computable dependency between the business metric and the computed metric;
computing at least one computed metric via the executable connector, the computed metric selected from the group consisting of:
an information technology resource metric;
a cost metrics of an information technology resource;
a service metrics of an information technology service; and
a cost metrics of an information technology service.
